(19) United States
(12) Patent Application Publication
(10) Pub. No.: US 2003/0025294 A1
(43) Pub. Date: Feb. 6, 2003

(54) Handlebar fastening assembly for mini cycle

(76) Inventor: Chu Sung Chen, Chang Hua Hsien (TW)

Correspondence Address: CHARLES E. BAXLEY, 5th Floor, 59 John Street, New York, NY, 10038, US

(21) Appl. No.: 09/920,187

(22) Filed: Aug. 2, 2001

(51) Int. Cl. B62M 15/00

(52) U.S. Cl. 280/270; 280/279

(57) ABSTRACT

A handlebar fastening device for a mini cycle includes a conduit rotatably secured in the head tube of the mini cycle and includes an upper end extended upward beyond the head tube, a handlebar support having a curved and integral one-piece structure and having a lower end secured to the upper end of the conduit, and having an upper and front end for supporting a handlebar with a barrel. The conduit includes an embossed outer peripheral surface for solidly engaging with the handlebar support. A bracket may secure the lower end of the handlebar support to the conduit.

### BACKGROUND OF THE INVENTION

1. Field of the Invention

The present invention relates to a mini cycle, and more particularly to a handlebar fastening assembly for mini cycles.

2. Description of the Prior Art

As shown in FIGS. 1 and 2, a typical mini cycle is illustrated and includes a head tube 9 secured and provided in the front portion of a cycle frame 11. A bracket 5 includes a conduit 6 extended upward therefrom and rotatably secured in the head tube 9, for rotatably attaching a front wheel 14 thereto. The conduit 6 includes a length greater than that of the head tube 9 such that the conduit 6 extends upward outward and beyond the head tube 9. A pipe 1 includes a lower portion slidably engaged in the conduit 6 and having an inclined surface 3 formed therein, and includes a shank 7 extended forward from the upper portion thereof for supporting a barrel 8 thereon. A handle 20 includes a handlebar 21 extended downward therefrom and secured to the barrel 8 with fasteners or the like. A cam lever 2 is rotatably secured on top of the pipe 1. A rod 23 is received in the pipe 1 and has an upper end pivotally secured to the lever 2, and has a lower end extended outward of the pipe 1. A wedge 4 is secured to the lower end of the rod 23 with such as the fasteners, and includes a corresponding inclined surface for engaging with the inclined surface 3 of the pipe 1, and for allowing the wedge 4 to be forced and moved laterally outward relative to the pipe 1 when the wedge 4 is moved and pulled relative to the pipe 1 by the lever 2. The shank 7 includes a front end secured to the barrel 8 with welding processes, and includes a rear end that is also required to be secured to the pipe 1 with welding processes, such that the shank 7 may be easily damaged or broken from the pipe 1. In addition, stress concentration problem may be formed or occurred between the shank 7 and the pipe 1 and the barrel 8. The welding and securing portion of the shank 7 to the pipe I suffer most of the force of the handle 20 applied onto the pipe 1, and will be the portion that may be easily broken from or relative to the pipe 1.

The present invention has arisen to mitigate and/or obviate the afore-described disadvantages of the conventional handlebars for mini cycles.

### SUMMARY OF THE INVENTION

The primary objective of the present invention is to provide a handlebar fastening assembly for mini cycle including an integral one-piece handlebar supporting member for preventing stress concentration problem and for preventing the handlebar supporting member from being easily broken from the cycle frame.

In accordance with one aspect of the invention, there is provided a handlebar fastening assembly for attaching to a mini cycle, the handlebar fastening assembly comprising a head tube for attaching onto the mini cycle, a conduit rotatably secured in the head tube and including an upper end extended upward from the head tube, a handlebar support including a curved and integral one-piece structure having a lower end secured to the upper end of the conduit, and having an upper and front end, a barrel secured on the upper and front end of the handlebar support, and a handle including a handlebar secured to the barrel.

The upper end of the conduit includes an embossed outer peripheral surface for solidly engaging with the lower end of the handlebar support.

A bracket is engaged onto the lower end of the handlebar support and the upper end of the conduit, and at least one fastener may secure the bracket to the lower end of the handlebar support and the upper end of the conduit.

The barrel is parallel to the conduit and includes a front portion having a slot formed therein for receiving the handlebar of different diameter to be received in the barrel.

The barrel includes a pair of ears extended forward therefrom, and means for securing the ears together to secure the handlebar in the barrel.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial exploded view of a typical handlebar fastening assembly for a typical mini cycle;

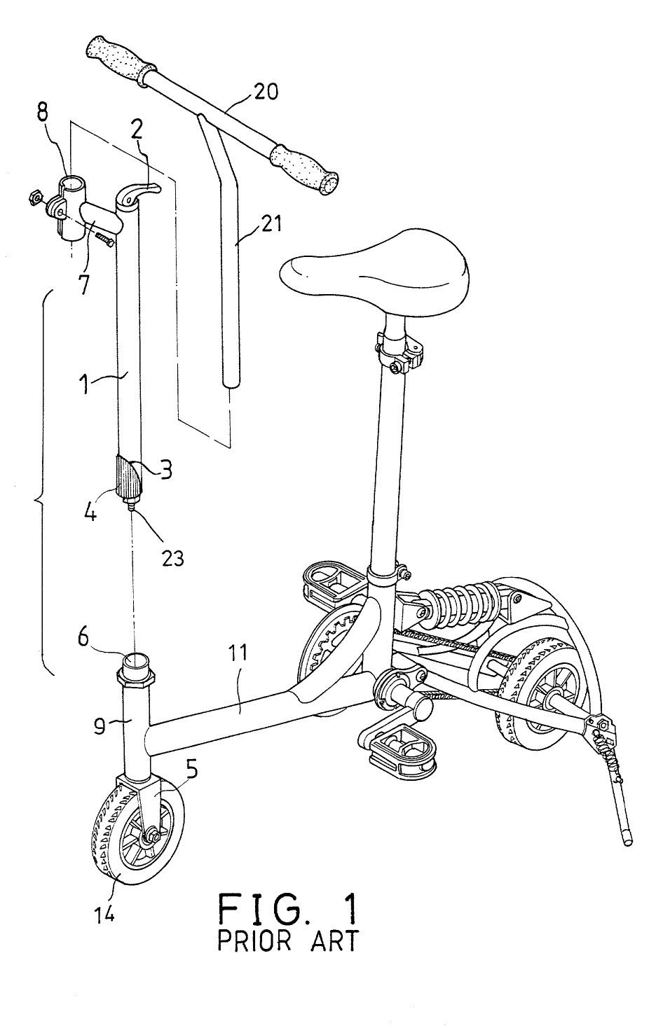

FIG. 2 is a partial cross sectional view of the typical handlebar fastening assembly for the typical mini cycle;

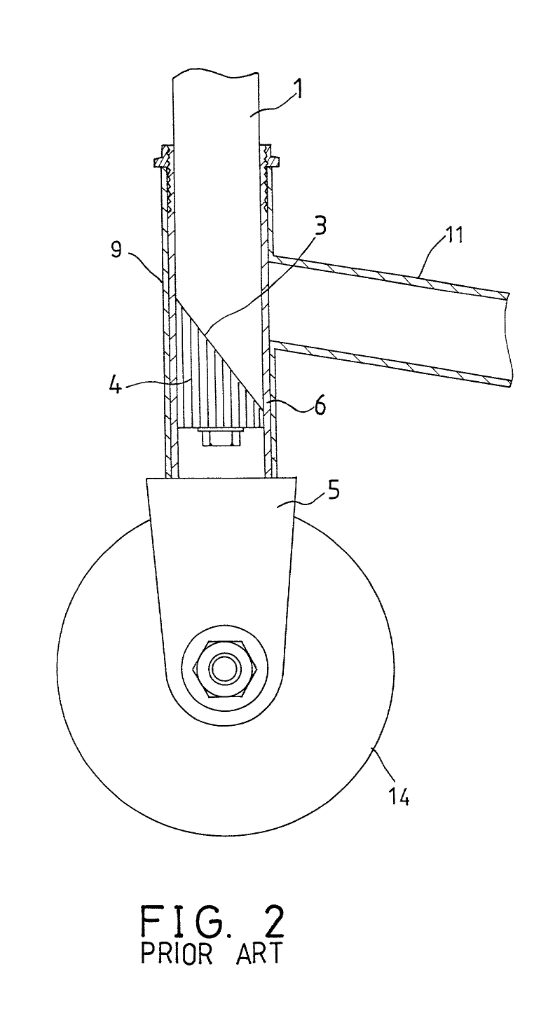

FIG. 3 is a partial exploded view of a handlebar fastening assembly for a mini cycle in accordance with the present invention; and

FIG. 4 is a partial cross sectional view of the handlebar fastening assembly for the mini cycle in accordance with the present invention.

### DETAILED DESCRIPTION OF THE PREFERRED EMBODIMENT

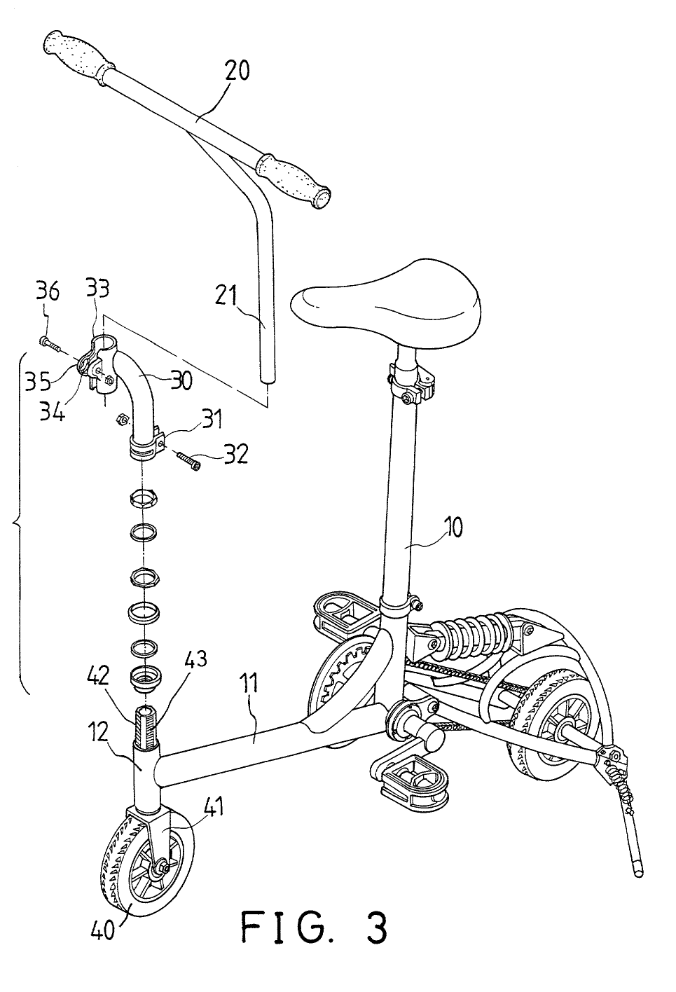

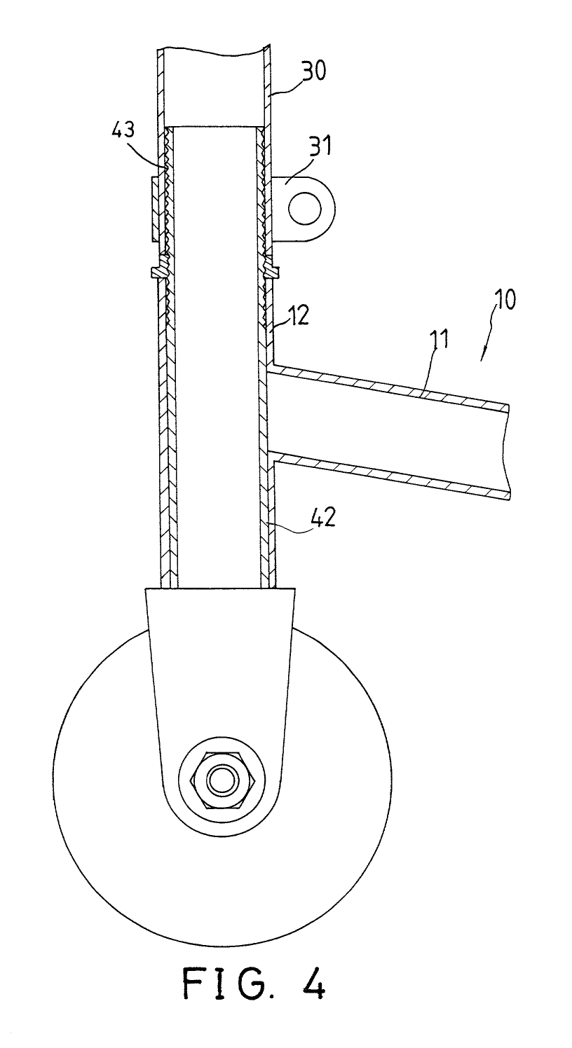

Referring to FIGS. 3 and 4, a handlebar fastening assembly in accordance with the present invention is provided for attaching to a mini cycle 10 which includes a head tube 12 secured and provided in the front portion of a cycle frame 11 of the mini cycle 10. A bracket 41 includes a conduit 42 extended upward therefrom and rotatably secured in the head tube 12, for rotatably attaching or supporting a front wheel 40 thereto. The conduit 42 includes a length greater than that of the head tube 12 such that the conduit 42 extends upward outward and beyond the head tube 12. The upper end of the conduit 42 includes a number of teeth or includes an embossed outer peripheral surface 43 formed thereon.

An elbow or a handlebar support 30 includes a curved structure and includes an integral one-piece structure having a lower portion engaged onto the upper end of the conduit 42 and secured to the conduit 42 with a bracket 31 and one or more fasteners 32 or the like. The bracket 31 is engaged onto and secured to the lower portion of the handlebar support 30 and the conduit 42 with the fasteners 32 or the like. The handlebar support 30 includes an upper and front portion having a barrel 33 secured thereto. The barrel 33 is about vertical or parallel to the conduit 42 and includes a slot 34 formed in the front portion thereof for allowing the handlebar 21 of various diameters to be engaged into the barrel 33. The barrel 33 includes a pair of ears 35 extended forward therefrom. A handle 20 includes a handlebar 21 extended downward therefrom and engaged into and secured to the barrel 33 with fasteners 36 or the like.

The most important characteristic of the handlebar fastening assembly in accordance with the present invention is that the handlebar support 30 includes a curved and integral one-piece structure having a lower portion engaged onto and secured to the upper end of the conduit 42 and having a barrel 33 provided on the upper and front portion thereof for supporting the handlebar 21. The lower portion of the curved and integral one-piece handlebar support 30 may be solidly engaged and secured onto the upper end of the conduit 42 by the teeth or the embossed outer peripheral surface 43 of the conduit 42 and the bracket 31 and the fastener 32. The curved and integral one-piece handlebar support 30 may suffer most of the force of the handle 20 applied onto the handlebar support 30, but will not be easily damaged or broken due to the integral and non-welding couplings provided therein.

Accordingly, the handlebar fastening assembly for mini cycle in accordance with the present invention includes an integral one-piece handlebar supporting member for preventing stress concentration problem and for preventing the handlebar supporting member from being easily broken from the cycle frame.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A handlebar fastening assembly for attaching to a mini cycle, said handlebar fastening assembly comprising:
a head tube for attaching onto the mini cycle,
a conduit rotatably secured in said head tube and including an upper end extended upward beyond said head tube,
a handlebar support including a curved and integral one-piece structure having a lower end secured to said upper end of said conduit, and having an upper and front end,
a barrel secured on said upper and front end of said handlebar support, and
a handle including a handlebar secured to said barrel.

2. The handlebar fastening assembly according to claim 1, wherein said upper end of said conduit includes an embossed outer peripheral surface for solidly engaging with said lower end of said handlebar support.

3. The handlebar fastening assembly according to claim 1 further comprising a bracket engaged onto said lower end of said handlebar support and said upper end of said conduit, and at least one fastener securing said bracket to said lower end of said handlebar support and said upper end of said conduit.

4. The handlebar fastening assembly according to claim 1, wherein said barrel is parallel to said conduit and includes a front portion having a slot formed therein for receiving said handlebar of different diameter to be received in said barrel.

5. The handlebar fastening assembly according to claim 4, wherein said barrel includes a pair of ears extended forward therefrom, and means for securing said ears together to secure said handlebar in said barrel.

6. A handlebar fastening assembly for attaching to a head tube of a mini cycle, said handlebar fastening assembly comprising:
a conduit for rotatably securing in said head tube of said mini cycle and including an upper end extended upward beyond said head tube,
a handlebar support including a curved and integral one-piece structure having a lower end secured to said upper end of said conduit, and having an upper and front end,
a handle including a handlebar extended therefrom, and
means for securing said handlebar to said barrel.

7. The handlebar fastening assembly according to claim 6, wherein said securing means includes a barrel secured on said upper and front end of said handlebar support for receiving said handlebar therein.

8. The handlebar fastening assembly according to claim 7, wherein said barrel is parallel to said conduit and includes a front portion having a slot formed therein for receiving said handlebar of different diameter to be received in said barrel.

9. The handlebar fastening assembly according to claim 8, wherein said barrel includes a pair of ears extended forward therefrom, and means for fastening said ears together to secure said handlebar in said barrel.

10. The handlebar fastening assembly according to claim 6, wherein said upper end of said conduit includes an embossed outer peripheral surface for solidly engaging with said lower end of said handlebar support.

11. The handlebar fastening assembly according to claim 6 further comprising a bracket engaged onto said lower end of said handlebar support and said upper end of said conduit, and at least one fastener securing said bracket to said lower end of said handlebar support and said upper end of said conduit.
